(19) United States
(12) Patent Application Publication
(10) Pub. No.: US 2008/0289921 A1
(43) Pub. Date: Nov. 27, 2008

(54) Shock absorber for switching-device operating device

(75) Inventors: Tomohito Mori, Tokyo (JP); Ken Komatsu, Tokyo (JP); Toru Yamashita, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 11/984,753

(22) Filed: Nov. 21, 2007

(30) Foreign Application Priority Data
May 23, 2007 (JP) 2007-137007

(51) Int. Cl. F16F 9/16

(52) U.S. Cl. 188/316

(57) ABSTRACT

A shock absorber includes a casing that is filled-in with a working fluid, a cylinder body that is housed in the casing and that forms chambers inside and outside the cylinder body, a sliding shaft that passes through the cylinder body and forms a flow path between the sliding shaft and the cylinder body and engages a movable contact, and a piston that is fixed to the sliding shaft and that is housed inside the cylinder body. An outer diameter of the piston is larger than a diameter of the sliding shaft. The piston can be slid in an inner peripheral surface of the cylinder body while ensuring waterproofing and causes the working fluid to move inside and outside the cylinder body and receives, due to a flow resistance at the time of the working fluid passing through the flow path, a braking force.

### BACKGROUND OF THE INVENTION

1. Field of the Invention

The present invention relates to a shock absorber of an operating device for switching operation of an electrical circuit of a power switching device which is installed, for example, in a substation or a switching station.

2. Description of the Related Art

There is a proposed shock absorber which includes a cylinder filled-in only with a specified quantity of working fluid and a movable piston provided inside the cylinder. In such a structure of the shock absorber, a predetermined gap (flow path) is formed between the piston and an inner periphery of the cylinder. The working fluid moves via the flow path between two chambers that are within the cylinder to provide a flow resistance used as a braking force. The piston has a through hole through which the working fluid flows while the piston moves in a direction in which the braking force is not required. A check valve is provided in the through hole.

In the shock absorber, if an open circuit operation progresses up to a predetermined position, the piston reaches a working fluid level. Upon reaching the working fluid level, the check valve occludes the through hole and the piston receives a reactive force due to the working fluid and moves up to an open circuit position. The reactive force functions as the braking force of the piston (for example, see Japanese Patent Application Laid-open No. H01-22696).

In the conventional shock absorber having the structure described above, a cross-sectional area of the flow path that is the cause for generation of the braking force depends upon a difference between an outer diameter of the piston and an inner diameter of the cylinder. For obtaining a large braking force, the outer diameter of the piston and the inner diameter of the cylinder need to be increased. If outer diameter dimensions of the piston are inaccurate and the cross-sectional area of the flow path varies widely, the braking force between devices also varies. Due to this, the outer diameter dimension of the conventional piston and the inner diameter dimension of the conventional cylinder need to be very accurate. Even if the piston is eccentric to the cylinder, the braking force between the devices varies depending upon the eccentricity. Thus, conventional components, such as the piston, the cylinder, a shaft bearing, and a piston rod, require highly accurate coaxiality. However, such a highly accurate structure involves a high cost. Further, when the piston reaches the working fluid level, a mechanical impulsive force is generated. Even if the check valve is provided to avoid dragging towards the piston rod upon the switching operation start-up, the mechanical impulsive force is generated when the check valve occludes the through hole.

### SUMMARY OF THE INVENTION

It is an object of the present invention to at least partially solve the problems in the conventional technology.

According to an aspect of the present invention, a shock absorber for a switching-device operating device that drives a movable contact that engages or disengages a stationary contact of a switching device includes a casing that is filled-in with a working fluid; a cylinder body that is housed inside the casing and forms chambers inside and outside the cylinder body; a sliding shaft that penetrates through the cylinder body and, upon forming a flow path between the cylinder body and the sliding shaft, engages the movable contact; and a piston that is fixed to the sliding shaft and housed inside the cylinder body, the piston having an outer diameter larger than a diameter of the sliding shaft, the piston sliding while ensuring a waterproofing in an inner peripheral surface of the cylinder body, and causing the working fluid to move inside and outside the cylinder body, the piston receiving, due to a flow resistance at the time of the working fluid passing through the flow path, a braking force.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a shock absorber for a switching-device operating device according to a first embodiment;

FIG. 2 is a schematic of the shock absorber in an open circuit status of a switching device;

FIG. 3 is a schematic of the shock absorber immediately after a closed circuit operation of the switching device is started;

FIG. 4 is a schematic of the shock absorber when the closed circuit operation of the switching device is in progress;

FIG. 8 is a schematic of the shock absorber after the open circuit operation of the switching device is complete; and

FIG. 9 is a schematic of a shock absorber for a switching-device operating device according to a second embodiment.

### DETAILED DESCRIPTION OF THE PREFERRED EMBODIMENTS

Exemplary embodiments of the shock absorber for a switching-device operating device according to the present invention are explained in detail below with reference to the accompanying drawings. However, the present invention is not limited to the embodiments.

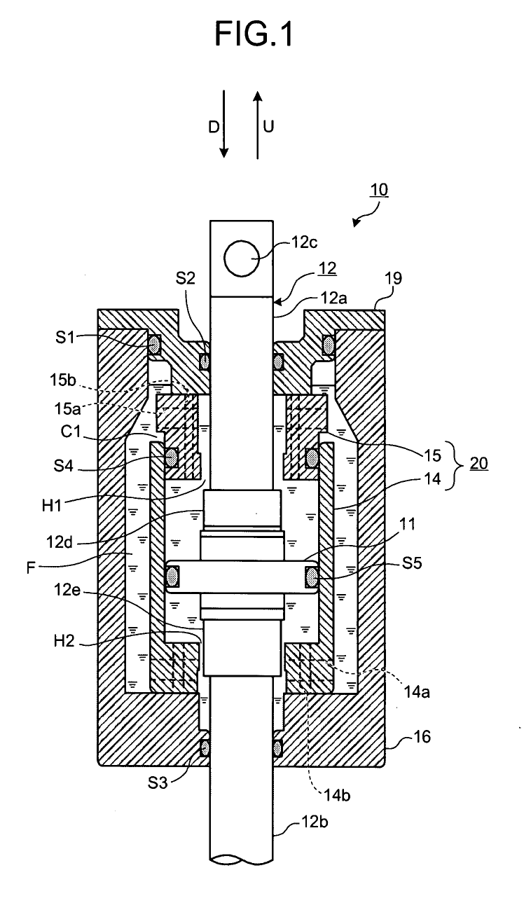

The shock absorber for the switching-device operating device according to a first embodiment of the present invention is explained with reference to drawings. FIG. 1 is a schematic of the shock absorber for the switching-device operating device according to the first embodiment of the present invention. In FIG. 1, a shock absorber 10 for the switching-device operating device is used in an operating device of a switching device that drives a movable contact that engages or disengages a stationary contact of the not shown switching device.

The shock absorber 10 includes a casing (cover) 16 that is internally filled-in with a working fluid F, a cylinder body 20 that is housed within the casing 16, a sliding shaft 12 that penetrates the cylinder body 20, and a piston 11 that is fixed to the sliding shaft 12 and housed within the cylinder body 20.

The casing 16 forms a cylindrical shape having a base and occludes an opening on the switching device side by a piston-pin bearing 19 and forms a closed space. The piston-pin bearing 19 is fixed to the casing 16 using fasteners such as bolts. A seal S1 (O ring) is provided between the casing 16 and the piston-pin bearing 19, thereby ensuring waterproofing. The sliding shaft 12 is provided such that the sliding shaft 12 can penetrate through the casing 16 and the piston-pin bearing 19. The piston 11 having a rough disk shape is fixed in an intermediate part of the sliding shaft 12. The sliding shaft 12 is formed by a first sliding shaft 12a that is on the switching device side and a second sliding shaft 12b that is on an opposite side with the piston 11 sandwiched therebetween. Thus, the first sliding shaft 12a, the second sliding shaft 12b, and the piston 11 are formed as one unit.

A coupler 12c that is connected to an output lever of the switching-device operating device is provided at the end of the first sliding shaft 12a. A seal S2 is provided in a through hole through which the first sliding shaft 12a penetrates the piston-pin bearing 19. Due to this, the first sliding shaft 12a can be slid with respect to the piston-pin bearing 19 by ensuring the waterproofing. Similarly, a seal 3 is provided in the through hole that is formed at a base part of the casing 16 through which the second sliding shaft 12b penetrates. Due to this, the second sliding shaft 12b can be slid with respect to the casing 16 by ensuring the waterproofing. In the casing 16, the water fluid F of a predetermined quantity is filled-in.

The cylinder body 20 includes a cylinder 14 of a cylindrical shape having the base and a cylinder head 15 that occludes the opening of the cylinder 14. The cylinder 14 includes a cylindrical body and a base that is formed along with the cylindrical body. The cylinder head 15 is fitted in the cylinder 14 by internally touching the opening of the cylindrical body, thereby enabling sliding of the cylinder head 15. A seal S4 is provided in a sliding surface between the cylinder 14 and the cylinder head 15, thereby ensuring the waterproofing. A gap C1 is formed between the cylinder 14 and the cylinder head 15. The cylinder 14 and the cylinder head 15 can relatively move only up to a shaft direction length of the gap C1. The cylinder body 20 that is housed within the casing 16 forms chambers inside and outside the cylinder body 20. In other words, one chamber is formed inside the cylinder body 20 and other chamber is formed between the cylinder body 20 and the casing 16.

A first large diameter hole H1 and a second large diameter hole H2 of a predetermined measurement that are larger than a diameter of the sliding shaft 12 are left in the base part of the cylinder head 15 and the cylinder 14. The sliding shaft 12 is penetrated through the first large diameter hole H1 and the second large diameter hole H2 and fixedly set up. A cylindrical gap of a predetermined width (flow path around the shaft) is formed between an outer peripheral surface of the first sliding shaft 12a and an inner peripheral surface of the first large diameter hole H1. Similarly, the cylindrical gap of the predetermined width (flow path around the shaft) is formed between the outer peripheral surface of the second sliding shaft 12b and the inner peripheral surface of the second large hole H2.

Further in the cylinder head 15, a horizontal flow path hole 15a that connects the outer chamber of the cylinder body 20 and the inner peripheral surface of the first large hole H1 penetrates in a direction perpendicular to the first sliding shaft 12a. Further, a vertical flow path hole 15b that connects an end face of the cylinder head 15 that comes into contact with the piston-pin bearing 19 and the inner chamber of the cylinder body 20 penetrates in the direction parallel to the first sliding shaft 12a. Similarly, in the base of the cylinder 14, a horizontal flow path hole 14a that connects the outer chamber and the inner peripheral surface of the second large diameter hole H2 of the cylinder body 20 penetrates in the direction perpendicular to the second sliding shaft 12b. Further, a vertical flow path hole 14b that connects a base surface of the base that comes into contact with the casing 16 and the inner chamber of the cylinder body 20 penetrates in the direction parallel to the second sliding shaft 12b.

The piston 11 having the rough disk shape includes a seal S5 in the outer periphery. The piston 11 internally touches the cylinder 14 via the seal S5. The piston 11 can be slid with respect to the inner peripheral surface of the cylinder 14 while ensuring the waterproofing. The piston 11 further divides the inner chamber of the cylinder body 20 into two chambers. Within the casing 16, the cylinder body 20 is only supported by the piston 11. Due to this, when the piston 11 moves in a shaft direction, the cylinder body 20 moves by following the piston 11. However, upon moving up to the length of the gap C1, the cylinder body 20 comes into contact with the casing 16. Thus, only the piston 11 moves after the cylinder body 20 comes into contact with the casing 16.

By following the switching operations of the operating device, if the sliding shaft moves in the shaft direction, the piston 11 slides inside the cylinder body 20. The piston 11 causes the working fluid F to move inside and outside the cylinder body 20. The gap between the outer peripheral surface of the first sliding shaft 12a and the inner peripheral surface of the first large diameter hole H1 and the gap between the outer peripheral surface of the second sliding shaft 12b and the inner peripheral surface of the second large diameter hole H2 is the respective flow path (flow path around the shaft) of the working fluid F. The flow resistance at the time of the working fluid F passing through the flow-path around the shaft becomes the braking force of the present embodiment and the piston 11 receives the braking force. In the outer peripheral surface of the first sliding shaft 12a and the outer peripheral surface of the second sliding shaft 12b, a tiered portion 12d and a tiered portion 12e is formed respectively. A severity of the braking force is decided according to a flow cross-sectional area of the flow path around the shaft. However, in the tiered portions 12d and 12e, the braking force is decided by changing a size of the diameter and a length of the shaft direction and adjusting the flow cross-sectional area of the flow path around the shaft. The working fluid F that passes through the flow path around the shaft is in a high-pressure status and after passing is complete, a pressure of the working fluid gradually becomes low. The working fluid F moves from inside to outside of the cylinder body 20 via the horizontal flow path holes 14a and 15a that are respectively arranged in the cylinder 14 and the cylinder head 15 and returns to the low pressure.

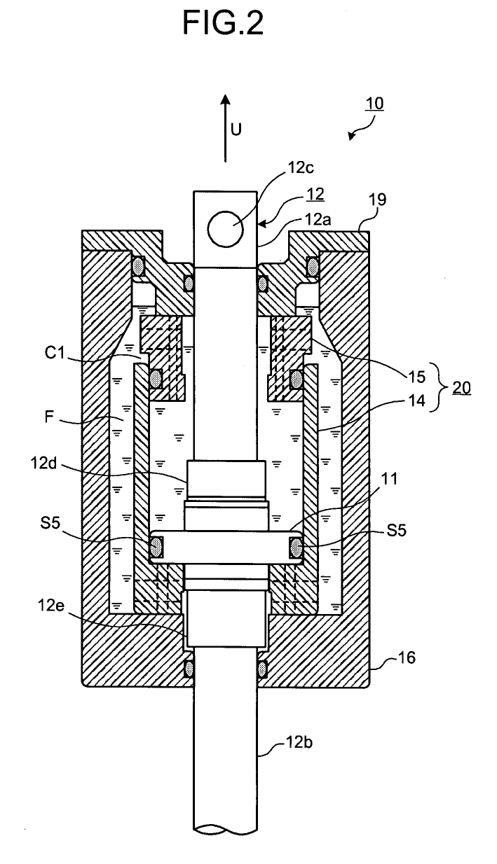

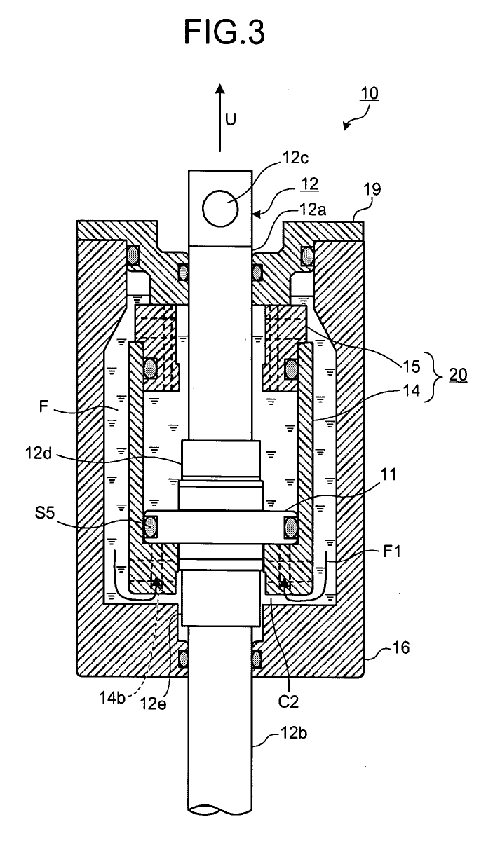

In operations explained below, closed circuit operations are explained first. If the closed circuit operations start from the open circuit status that is indicated in FIG. 2, the coupler 12c is pulled in an arrow direction U and the first sliding shaft 12a and the second sliding shaft 12b, the piston 11, and the seal S5 start moving as one unit. Before the movement is started, the piston 11 is attached to the base part of the cylinder 14. Because a gap is not left between the two parts, a dragging that hinders the movement of the piston 11 occurs. Because the gap C1 is already arranged between the cylinder 14 and the cylinder head 15 for enabling the cylinder 14 to move in an arrow direction D and the arrow direction U (see FIG. 1), immediately after the movement of the piston 11 is started, the cylinder 14 that is attached to the piston 11 that is shown in FIG. 3 starts moving along with the piston 11. Due to this, a gap C2 is generated between the cylinder 14 and the casing 16. As shown in an arrow F1, the working fluid F flows from the vertical flow path hole 14b that is provided in the cylinder 14 to the attached part of the piston 11 and the cylinder 14, thereby, releasing the attached part. Without any occurrence of the dragging, the movement is carried out smoothly.

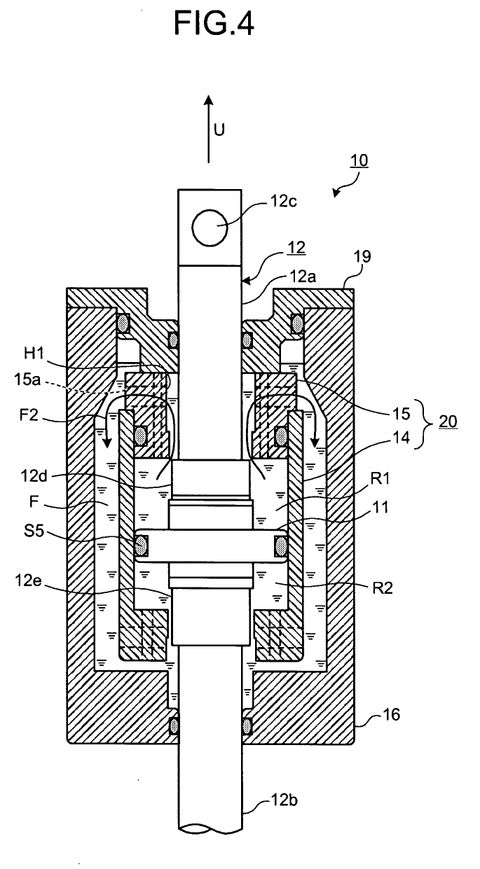

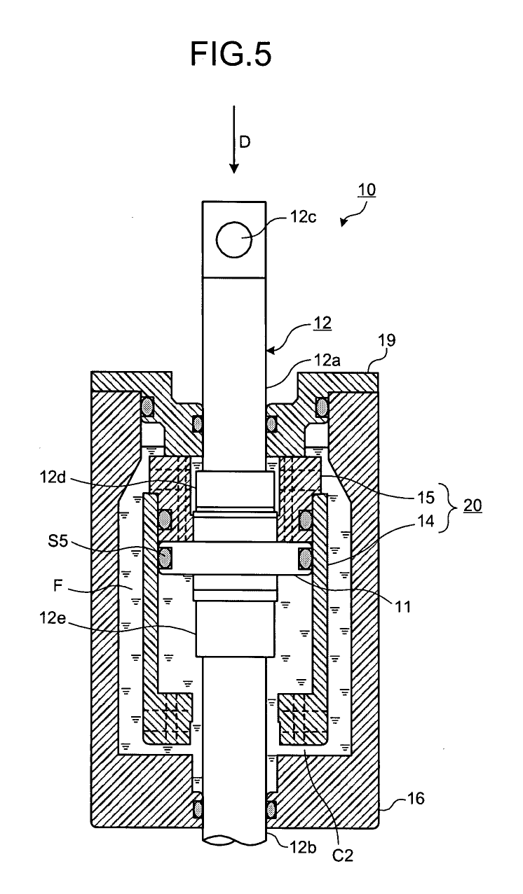

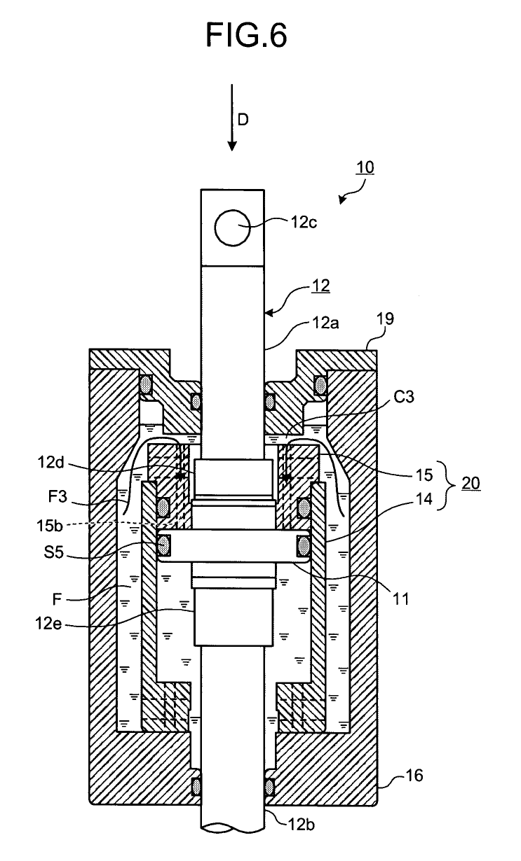

As shown in FIG. 4, due to the piston 11, two chambers such as a chamber R1 at the cylinder head 15 side and a chamber R2 at the cylinder 14 side are formed inside the cylinder body 20. The chamber R1 gradually becomes small and the chamber R2 gradually becomes large. As shown in an arrow F2, the working fluid F inside the chamber R1 flows to the low pressure side of the cylinder head 15 via the flow path between the first sliding shaft 12a and the first large diameter hole H1 and further flows via the horizontal flow path hole 15a that is provided in the cylinder head 15. Finally the working fluid F is discharged to the low-pressure area that is formed between the cylinder body 20 and the casing 16. The braking force is obtained due to the flow resistance at the time of the working fluid F passing through the flow path between the first sliding shaft 12a and the first large diameter hole H1 at the time of the operation. Based on the tiered portion 12d of the first sliding shaft 12a, the flow path cross-sectional area can be adjusted, thereby enabling to obtain the suitable braking force. As shown in FIG. 5, upon touching the cylinder head 15, the piston 11 is stopped and the closed circuit operation is completed. The stop position is considered as the closed circuit position.

The open circuit operations are explained below. Upon starting the open circuit operations from a closed circuit status that is indicated in FIG. 5, the coupler 12c is pushed in the arrow direction D and the first sliding shaft 12a and the second sliding shaft 12b, the piston 11, and the seal S5 start moving as one unit. Before the movement is started, the piston 11 is attached to the cylinder head 15. Because the gap is not left between the two parts, the dragging that hinders the movement of the piston 11 occurs and because the gap C2 is provided between the cylinder 14 and the casing 16, the cylinder head 15 can move in the arrow direction D along with the cylinder 14. Immediately after the movement of the piston 11 is started, the cylinder head 15 that is attached to the piston 11 moves along with the cylinder 14 as shown in FIG. 6. Due to this, a gap C3 is generated between the cylinder head 15 and the piston-pin bearing 19. As shown in an arrow F3, the working fluid F flows from the vertical flow path hole 15b that is provided in the cylinder head 15 to the attached part of the piston 11 and the cylinder head 15, thereby enabling to release the attached part. Without any occurrence of the dragging, the movement is carried out smoothly.

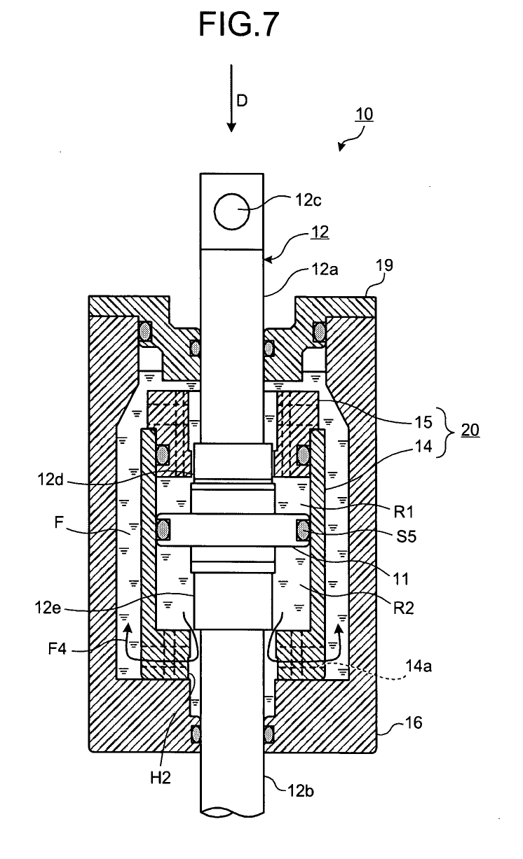

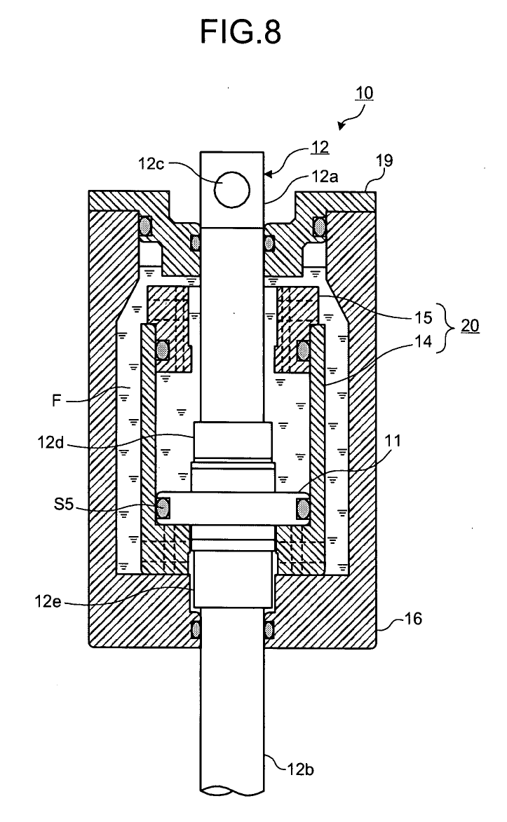

As shown in FIG. 7, due to the piston 11, two chambers such as the chamber R1 at the cylinder head 15 side and the chamber R2 at the cylinder 14 side are formed inside the cylinder body 20. The chamber R2 gradually becomes small and the chamber R1 gradually becomes large. As shown in an arrow F4, the working fluid F inside the chamber R2 flows to the low pressure side of the cylinder 14 via the flow path between the second sliding shaft 12b and the second large diameter hole H2 and further flows via the horizontal flow path hole 14a that is provided in the cylinder 14. Finally the working fluid F is discharged to the low-pressure area that is formed between the cylinder body 20 and the casing 16. The braking force is obtained due to the flow resistance at the time of the working fluid F passing through the flow path between the second sliding shaft 12b and the second large diameter hole H2 at the time of the operation. Based on the tiered portion 12e of the second sliding shaft 12b, the flow path cross-sectional area can be adjusted, thereby enabling to obtain the suitable braking force. As shown in FIG. 8, upon touching the cylinder 14, the piston 11 is stopped and the open circuit operation is completed. The stop position is considered as the open circuit position.

Because the shock absorber according to the present embodiment is structured as mentioned earlier, the working fluid F moves through the flow path (flow path around the shaft) that is formed due to the gap formed between the first sliding shaft 12a and the second sliding shaft 12b (including the tiered portions 12d and 12e) of a small diameter when compared with the piston 11 and the first large diameter hole H1 and the second large diameter H2. In other words, with respect to the flow path that is formed around the periphery of the conventional piston of a large diameter, in the present embodiment, the flow path is formed around the first sliding shaft 12a and the second sliding shaft 12b of the small diameter. Thus, depending upon variations in the diameter dimensions, fluctuations in the flow path cross-sectional area can be reduced. Without strictly managing the diameter dimensions, the variations in the braking force between the shock absorbers can be reduced. Because the cylinder body 20 is only supported by the piston 11, the cylinder body 20 and the piston 11 are naturally coaxial. Further, without requiring a high dimensional accuracy, the coaxiality of the piston 11, the cylinder 14, and the cylinder head 15 is preserved. Thus, because the first sliding shaft 12a and the second sliding shaft 12b are not eccentric to the large diameter hole Hi and the large diameter hole H2, the flow path does not slant and the variations in the braking force between the shock absorbers can be reduced. Further, immediately after the open circuit and the closed circuit operations are started, the piston 11 and the cylinder 14 or the piston 11 and the cylinder head 15 are attached. Thus, the cylinder 14 and the cylinder head 15 can move up to the predetermined measurement along with the piston 11. Further, in the cylinder 14 and the cylinder head 15, because the vertical flow path holes 14b and 15b are arranged, the occurrence of the dragging related to the piston 11 is inhibited, thereby enabling smooth operations immediately after the operation is started.

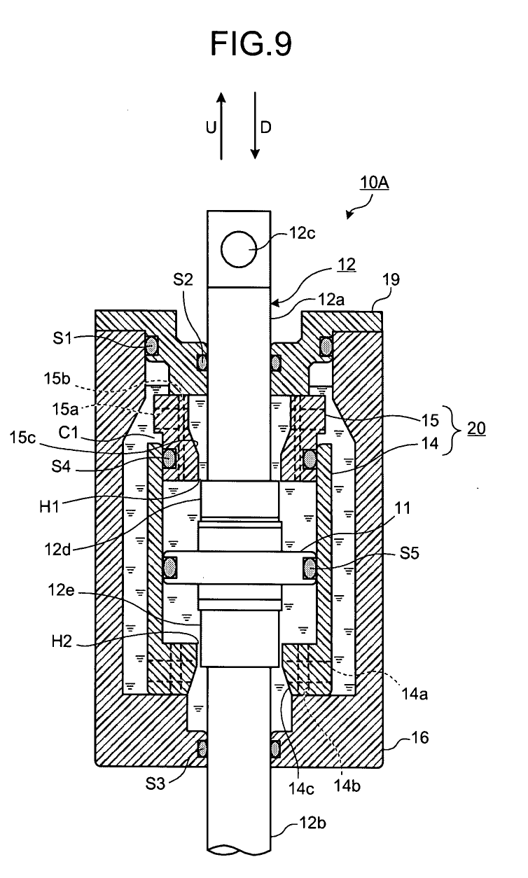

FIG. 9 is a schematic of a shock absorber for a switching-device operating device according to a second embodiment of the present invention. In FIG. 9, in a shock absorber 10A according to the present embodiment, the inner peripheral surface of the cylinder head 15, in other words, a surface that is facing the first large diameter hole H1 of the cylinder head 15 is a taper surface 15c. With respect to the flow path around the shaft that is formed in the gap between the outer peripheral surface of the first sliding shaft 12a and the inner peripheral surface of the first large diameter hole H1, the taper surface 15c is changed such that the flow path cross-sectional area can gradually become large (small). In the shock absorber 10A according to the present embodiment, the inner peripheral surface of the base part of the cylinder 14, in other words, the surface facing the second large diameter hole H2 of the cylinder 14 is a taper surface 14c. With respect to the flow path around the shaft that is formed in the gap between the outer peripheral surface of the second sliding shaft 12b and the inner peripheral surface of the second large diameter hole H2, the taper surface 14c is changed such that the flow path cross-sectional area can gradually become large (small). Remaining structure of the shock absorber 10A is similar to the first embodiment.

At the time of the closed circuit operation, the coupler 12c is pulled in the U direction and the first sliding shaft 12a and the second sliding shaft 12b, the piston 11 and the seal S5 are moved in U direction as one unit. The working fluid F passes through the flow path around the shaft that is formed by the tiered portion 12d of the first sliding shaft 12a and the first large diameter hole H1 with the high pressure. Because the flow path cross-sectional area gradually becomes large due to the taper surface 15c, the working fluid F gradually moves to the low pressure from the high pressure and is discharged to the low-pressure area via the horizontal flow path hole 15a. However, at the time of the open circuit operation, the coupler 12c is pushed in the D direction and the first sliding shaft 12a and the second sliding shaft 12b, the piston 11, and the seal S5 are moved in the D direction as one unit. The working fluid F passes through the flow path around the shaft that is formed by the tiered portion 12e of the second sliding shaft 12b and the second large diameter hole H2 with the high pressure. Because the flow path cross-sectional area gradually becomes large due to the taper surface 14c, the working fluid F gradually moves to the low pressure from the high pressure and is discharged to the low-pressure area via the horizontal flow path hole 14a. Remaining operations are similar to the first embodiment.

Because the shock absorber according to the present embodiment is structured as mentioned earlier, when the working fluid F passes through the flow path that is formed by the tiered portions 12d and 12e of the first sliding shaft 12a and the second sliding shaft 12b, the large diameter holes H1 and H2 with the high pressure, because the flow path cross-sectional area gradually becomes large due to the taper surfaces 14c and 15c, the working fluid F does not move rapidly to the low pressure status from the high pressure status. Because the air included in the working fluid F that is compressed with the high pressure does not appear as bubbles, even in the repetitive operations, the braking force is stable.

According to an embodiment of the present invention, because a flow path is formed around a sliding shaft between the sliding shaft and a cylinder body, even if an outer diameter of a piston and an inner diameter of a cylinder is increased to obtain a large braking force, variations in the braking force can be reduced without increasing a dimensional accuracy of the piston and the cylinder.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A shock absorber for a switching-device operating device that drives a movable contact that engages or disengages a stationary contact of a switching device comprising:
a casing that is filled-in with a working fluid;
a cylinder body that is housed inside the casing and forms chambers inside and outside the cylinder body;
a sliding shaft that penetrates through the cylinder body and, upon forming a flow path between the cylinder body and the sliding shaft, engages the movable contact; and
a piston that is fixed to the sliding shaft and housed inside the cylinder body, the piston having an outer diameter larger than a diameter of the sliding shaft, the piston sliding while ensuring a waterproofing in an inner peripheral surface of the cylinder body, and causing the working fluid to move inside and outside the cylinder body, the piston receiving, due to a flow resistance at the time of the working fluid passing through the flow path, a braking force.

2. The shock absorber for the switching-device operating device according to claim 1, wherein
the cylinder body is slidably supported by the piston.

3. The shock absorber for the switching-device operating device according to claim 1, wherein
the sliding shaft has a tiered portion capable of adjusting a flow cross-sectional area of the flow path by changing a size of a diameter or a length in a shaft direction.

4. The shock absorber for the switching-device operating device according to claim 1, wherein
the cylinder body includes a cylinder and a cylinder head, the cylinder having a cylindrical body, the cylinder head occluding an opening of the cylindrical body, wherein the cylinder head is supported by fitting on the opening of the cylindrical body.

5. The shock absorber for the switching-device operating device according to claim 4, wherein
the cylinder is supported by the piston in a manner that the outer peripheral area of the piston slidably comes into contact with an inner peripheral surface of the cylindrical body for ensuring waterproofing.

6. The shock absorber for the switching-device operating device according to claim 4, wherein
the cylinder is slidable in the same direction as the piston, and
the cylinder has a through hole, the working fluid inflowing, through the through hole, between the cylinder and the piston that is in contact with the cylinder at a time of operation start-up of the piston, so that the piston does not come into contact with the cylinder.

7. The shock absorber for the switching-device operating device according to claim 4, wherein
the cylinder head is slidable in the same direction as the piston, and
the cylinder head has a through hole, the working fluid inflowing, through the through hole, between the cylinder head and the piston that is in contact with the cylinder at a time of operation start-up of the piston, so that the piston does not come into contact with the cylinder head.

8. The shock absorber for the switching-device operating device according to claim 1, wherein
the flow path includes a path formed by a tapered inner wall that gradually changes a cross-sectional area of the path.
